(19) United States
(12) Patent Application Publication
(10) Pub. No.: US 2009/0188224 A1
(43) Pub. Date: Jul. 30, 2009

(54) OPERATING A ROTARY MOWER USING GEARBOX TEMPERATURE

(76) Inventors: Don Assie, Vonda (CA); Blake Neudorf, Vonda (CA); Cam Wilson, Vonda (CA)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/021,973

(22) Filed: Jan. 29, 2008

(51) Int. Cl. A01D 34/66; A01D 34/74; A01D 69/02; G01M 19/00

(52) U.S. Cl. 56/7; 56/364; 56/10.8; 701/30

(57) ABSTRACT

With a rotary mower having a driveline including a plurality of gearboxes, a method of operating the rotary mower includes providing a sensor operative to measure a temperature of each gearbox in the driveline; monitoring the temperature in each gear box; and operating the mower to maintain the temperature of each gearbox at a level below a maximum acceptable temperature.

This Utility patent application claims priority to Canadian Patent Application No. ______ filed on Dec. 18, 2007, which is incorporated herein by reference.

### BACKGROUND

This invention is in the field of rotary mowers and in particular is concerned with an improved method of operating such a mower using conditions sensed in the gearbox, such as temperature, as a guide.

A typical rotary mower includes one or more rotating blade assemblies mounted for movement along the ground to cut vegetation. The blade assemblies rotate about vertical axes, and are driven from the power take off (pto) shaft of a towing tractor that spins about a generally horizontal axis. Thus a gear box is required at the top of each blade assembly to convert the rotation about the horizontal axis to rotation about the vertical axis. A drive shaft connects the pto shaft to a first gear box on the mower, which is in turn connected to other drive shafts connecting further downstream gearboxes to form a driveline comprising numerous gearboxes and drive shafts to connect each blade assembly to the pto shaft.

The first gearbox must be designed to transmit all the power being used by all the blade assemblies of the mower, but gear boxes farther downstream in the driveline transmit less power as the drive shafts split off to each blade assembly, and the gearbox at the top of each blade assembly is only required to transmit the power required by that single assembly. Thus the first gearbox on a mower with three equal sized blade assemblies, may be designed and rated to transmit 90 horsepower (HP) while the gearboxes at the top of the blade assemblies are only required and rated to transmit 30 HP to the blade assembly they are driving.

The power output at the towing tractor's pto shaft should be selected to substantially correspond to the power rating of the mower. The power drawn by the mower and transmitted through the driveline varies with the speed of travel of the mower and the amount of vegetation being cut. The operator generally balances these factors when operating the mower to substantially utilize the power available. The operator will watch the engine speed and when the engine begins to lug down, such as where the vegetation is high and dense, the operator will slow the travel speed, and when the vegetation gets thinner, the operator will increase the travel speed. The operator may also reduce the width of vegetation cut to reduce the power requirements of the mower.

As power is transmitted through the gearboxes, the meshing gears and rotating bearings generate heat, and the gear boxes are generally designed to operate at some elevated design temperature when the maximum rated power is being transmitted. Generally, operating above the design temperature can lead to failure of seals and loss of lubricating oil leading to failure of the gearbox. Elevated temperatures may also decrease the effectiveness of lubricating oil, and lead to failure of the meshing gears.

Elevated temperatures generally indicate some wear or pending failure in a gearbox. Exceeding the power rating of a gearbox can also cause the gearbox to overheat. Monitoring conditions such as temperature and vibration is known in various rotating equipment to detect defects. U.S. Pat. No. 6,425,293 to Woodruffe et al. for example discloses a sensor plug for sensing operating conditions in a gearbox. Woodruffe states that excessive vibration in the gearbox is an indication of malfunction, such as broken gear teeth, worn bearings, misaligned shafts and the like, which can lead to machine failure. Woodruffe also discusses monitoring gearbox temperatures to detect over-heating of bearings and gears, and suggests cooling the gearbox when elevated temperatures are detected by fans, spraying cooling liquid, connecting a climate control unit, and like measures.

### SUMMARY

It is an object of the present invention to provide a method of operating a rotary mower that overcomes problems in the prior art.

The present invention provides a method of operating a rotary mower where the rotary mower comprises a driveline including a plurality of gearboxes. The method comprises providing a sensor operative to measure a temperature of each gearbox in the driveline; monitoring the temperature in each gear box; operating the mower to maintain the temperature of each gearbox at a level below a maximum acceptable temperature.

In many rotating drive applications it is not practical to reduce the power transmitted through the driveline. The load on many rotating machines is substantially constant, and the machine is operated at a set power level to accomplish the task at hand.

Operating a rotary mower, however, is an operation where the amount of power being transferred through the mower driveline varies considerably with ground speed and the amount of vegetation being cut. The mower operator knows when the power drawn by the mower exceeds the power available at the tractor pto because the engine speed will drop, and either the sound of the engine or a look at the tachometer will advise the operator, who can then reduce the load by slowing down ground speed or cutting a narrower swath. Although it is generally desired to conduct a mowing operation at a consistent cutting height, in some conditions the operator may reduce power requirements by raising the mower to cut less vegetation. The operator may then be required to make a second pass over the same ground with the mower set at the desired height. The operator in some manner is then able to match the varying power requirements of the mower to the substantially constant power available from the tractor.

Problems arise where the power available at the tractor pto substantially exceeds the power rating of the mower. The operator then has no readily available indicator of whether the power being transmitted through the mower driveline exceeds the rated power of the driveline, and the gearboxes can overheat and be damaged. Weather also can significantly affect the temperature of a gearbox. When the ambient temperature is very hot, the gear boxes may exceed the design operating temperature even when the power being transmitted is at or below the rated power of the gearbox, leading to failure due to overheating.

A further problem arises when an operator reduces the load by reducing the width of cut. A mower might have three equal sized blade assemblies mounted on the left, middle, and right portions of the mower, and be designed to have a load of 90 HP. Thus the first gearbox on the mower is connected to the tractor pto and is rated to transmit 90 horsepower (HP). This first 90 HP gearbox is often mounted on top of the middle blade assembly and has an output shaft extending down to drive the middle blade assembly, and right and left output shafts connected to right and left gear boxes at the top of the right and left blade assemblies. The right and left gearboxes are only required and rated to transmit 30 HP to the corresponding right and left blade assemblies.

Thus when the mower is cutting full width each blade assembly is drawing about an equal amount of power. When the vegetation gets more dense, and the load increase drawing down the tractor engine speed, the operator may move toward the side that has been cut on a previous pass of the mower to reduce the width of cut. Thus the load on the left blade assembly will be reduced, and the engine speed will pick up and the operator will proceed with mowing, the tractor again delivering 90 HP to the mower. The distribution of the power is however now unbalanced—the left blade assembly may only be drawing 10 HP, while the middle and right blade assemblies are each drawing 40 HP. This may not be problematic for the 90 HP gearbox driving the middle blade, but the gearbox driving the right blade is transmitting 40 HP instead of its rated 30 HP. The risk of overheating and damage is substantially increased where the power transmitted through the gearbox exceeds the rated power.

Even when cutting a full width with the mower, it is not uncommon for the density of the vegetation to vary across the width, causing unbalanced loading of the gearboxes on the mower. The total power requirement will be at or under the rated power so that the operator will be unaware of the condition. By indicating the temperature of each gearbox to the operator, the operator can take whatever remedial action is required to ensure that one of the gearboxes is not experiencing an excessive temperature indicating that the gearbox is overloaded and exceeding its power rating.

Thus gearbox temperatures can rise because power requirements and ambient temperatures combine to raise the temperature in a gearbox that is structurally sound, or because the gearbox is damaged.

Regardless of the reason for the rise in gearbox temperature, there is a temperature threshold where the gearbox seals and the lubricating oil will no longer stand up to the temperature, and will be damaged. Thus advising the operator of the gearbox temperature in a mower can allow the operator to take steps to prolong the life of a damaged gearbox while provision is being made to replace or repair the gearbox, or to protect the gearbox from damage when conditions cause a sound gearbox to overheat. For example it may be that extremely high ambient temperatures are causing overheating without drawing down the tractor engine speed. The operator can reduce travel speed and thus power consumption to reduce the temperature of the gear box until ambient temperature falls, and normal operation can resume. Similarly where uneven vegetation is causing excessive loads in one gearbox while the total load is under the rated load, the operator will be made aware of the condition, and can slow the travel speed.

Where the gearbox temperature rises because the gearbox is damaged or worn, the operator will be warned of the condition. For example it may be that a seal has failed, and thus the operator may be able to continue operations by periodically adding lubricating oil to the gearbox to prevent damage to the gears until a convenient time for making a proper repair. Costly replacement and repair of the gears may be avoided.

The operator is provided with constant temperature monitoring of each gearbox using an actual temperature readout, and an audible or visible alarm may also be provided.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic top view of a rotary mower adapted for practicing a method of the present invention;

FIG. 2 is a schematic front view of a temperature gauge set for use with the mower of FIG. 1;

FIG. 3 is a schematic top view of the rotary mower of FIG. 1 operating in a full width cut position and a reduced width cut position;

FIG. 4 is a schematic side view of the rotary mower of FIG. 1 operating in a low cutting position and a raised cutting position;

FIG. 5 is a schematic side view of the a gearbox of the rotary mower of FIG. 1 showing a leaking seal.

### DETAILED DESCRIPTION

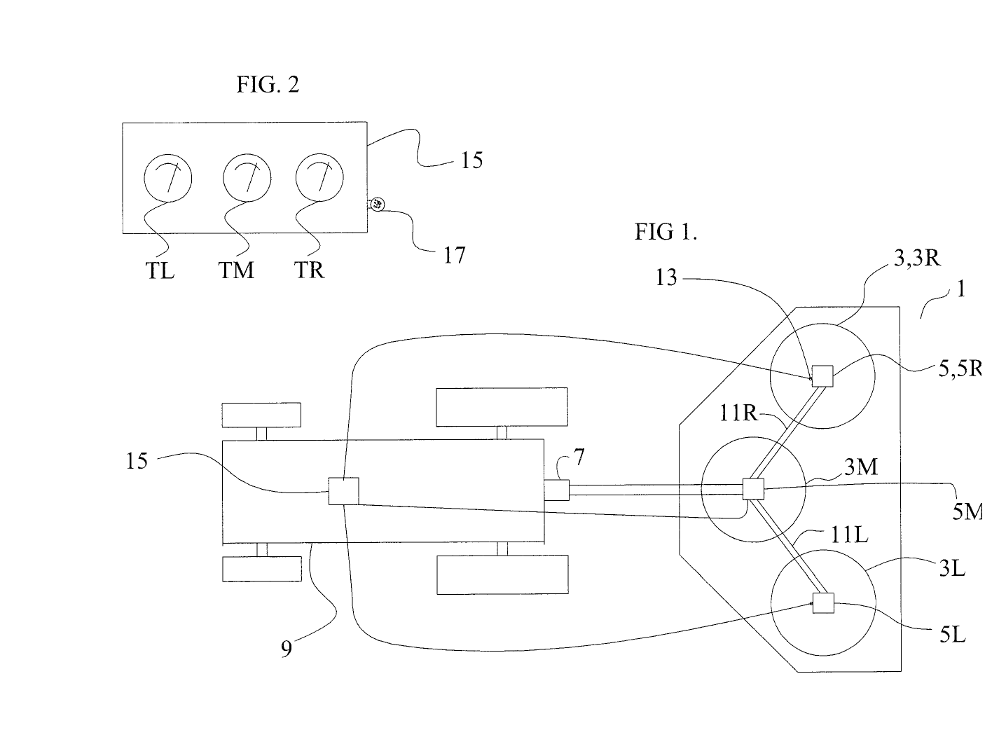

FIG. 1 schematically illustrates a rotary mower 1 for use with the method of the present invention. The rotary mower comprises three equal sized blade assemblies 3 mounted on the left, middle, and right portions of the mower 1, and a driveline including a plurality of gearboxes 5. The middle gearbox 5M is connected to the pto shaft 7 of the towing tractor 9. The gearbox 5M is mounted on top of the middle blade assembly 3M and has an output shaft (not shown) extending down to drive the middle blade assembly 3M, and right and left output shafts 11R, 11L connected to right and left gear boxes 5R, 5L at the top of the right and left blade assemblies 3R, 3L.

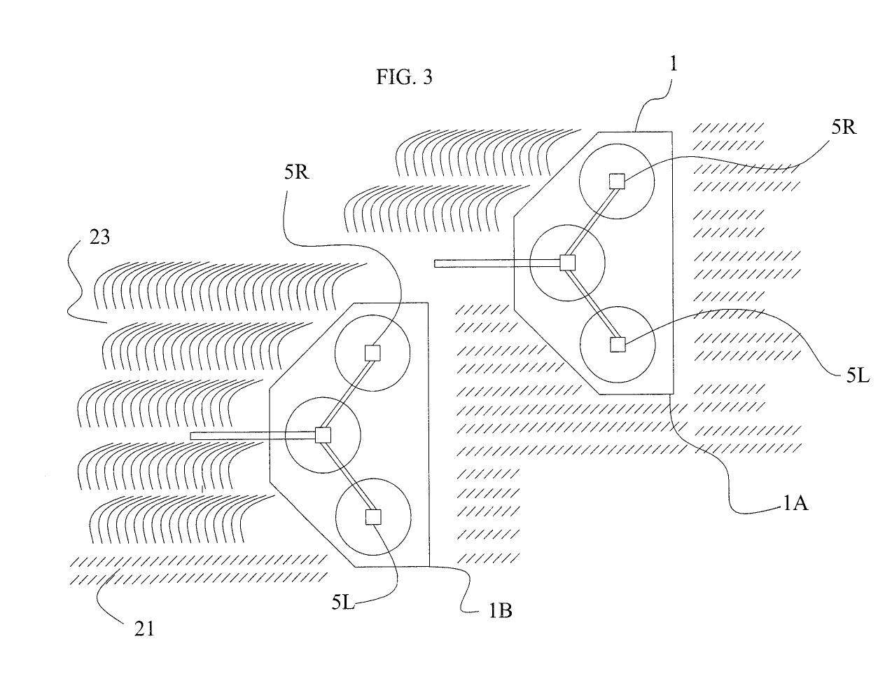

Temperature sensors 13 are provided in each gearbox 5 and are operative to measure a temperature of each gearbox 5 and are connected to indicate the temperatures on a gauge set 15, such as is illustrated in FIG. 2, located where the operator of the tractor 9 can monitor the temperatures TR, TM, TL in each gear box 5R, 5M, 5L. The operator can then operate the mower to maintain the temperature of each gearbox 5 at a level below a maximum acceptable temperature for the gearbox 5 being monitored. An alarm 17 is operative to alert the operator, with an audible or visible alarm signal, that the temperature of a gearbox 5 exceeds the maximum acceptable temperature.

By monitoring the temperature of the gear boxes 5, the operator can operate the mower 1 to maintain the temperature of each gearbox 5 at a level below a maximum acceptable temperature. When the temperature of a gearbox 5 exceeds the maximum acceptable temperature, the operator can reduce the travel speed of the mower 1 and monitor the temperature to see if it falls to an acceptable level.

Similarly in some conditions the operator may be able to reduce a width of cut of the mower 1 as illustrated in FIG. 3 by moving from the full width cutting position 1B to the partial cutting width position 1A. By reducing the width of cut as illustrated, the power transmitted through gearbox 5L is reduced, since the blade assembly driven by the gearbox 5L is passing over a previously cut strip of vegetation 21 instead of passing over the uncut vegetation 23. The blade assembly driven by the right gearbox 5R however is passing over the same uncut vegetation 23 in both positions 1A and 1B, and so reducing the width of cut as illustrated will not reduce power requirements through gearbox 5R. The gauge set 15 will indicate to the operator a lower temperature TL in gearbox 5L, but no change in the temperature TR of the gearbox 5R. With reduced load on gearbox 5L, there may in fact be an increase in the temperature of the gearbox 5R if the power not required by gearbox 5L is drawn through gearbox 5R.

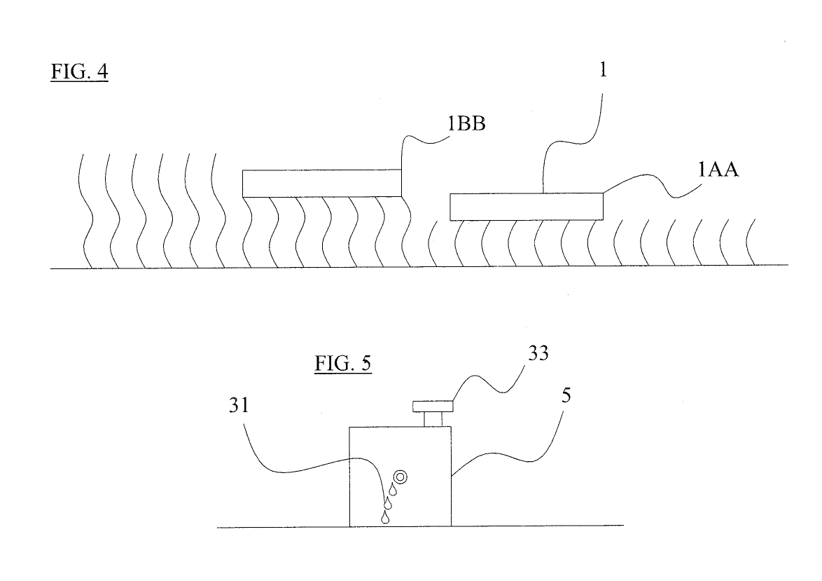

As illustrated in FIG. 4 the operator may reduce power requirements to lower gearbox temperatures by raising the mower 1 from position 1AA to position 1BB to cut less vegetation. The operator may then be required to make a second pass over the same ground with the mower 1 set at the desired height.

In any event, the operator is able to monitor each temperature and operate to maintain all the gearbox temperatures at an acceptable level. Where the operator detects that a gearbox seal is leaking lubricating oil 31, as illustrated in FIG. 5, the operator can periodically add lubricating oil to the gearbox through the filler port 33 to maintain the temperature of the gear box 5 at an acceptable level. The operator can perform preventive maintenance to correct worn or improperly adjusted gearbox components when that is the cause of the increased temperature.

It is contemplated that the operator will be able in numerous other similar ways to keep the mower operating in at least a somewhat satisfactory manner while avoiding incurring further damage to a damaged gearbox, or in some situations stop the mowing operation, and thus avoid costly repairs and downtime.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method of operating a rotary mower, the rotary mower comprising a driveline including a main drive shaft connecting a tractor power take off to a middle gearbox, wherein the middle gearbox drives a middle blade and the middle gearbox drives right and left gearboxes and the middle gearbox is rated to transfer a total power requirement therethrough, and the right and left gearboxes are rated to transfer a partial power requirement therethrough, and wherein the partial power requirement is less than one half of the total power requirement, the method comprising:
providing a sensor operative to measure a temperature of each gearbox in the driveline;
monitoring the temperature in each gearbox; and
operating the mower to maintain the temperature of each gearbox at a level below a maximum acceptable temperature.

2. The method of claim 1 further comprising providing an alarm operative to alert an operator that the temperature of a gearbox exceeds the maximum acceptable temperature.

3. The method of claim 1 wherein operating the mower to maintain the temperature of each gearbox at a level below a maximum acceptable temperature comprises, when the temperature of a gearbox exceeds the maximum acceptable temperature, one of reducing a travel speed of the mower and increasing a cutting height of the mower.

4. (canceled)

5. (canceled)

6. A method of operating a rotary mower, the rotary mower comprising a main drive shaft connecting a tractor power take off to a middle gearbox, wherein the middle gearbox drives a middle blade and the middle gearbox drives right and left gearboxes and the middle gearbox is rated to transfer a total power requirement therethrough, and the right and left gearboxes are rated to transfer a partial power requirement therethrough, and wherein the partial power requirement is less than one half of the total power requirement, the method comprising:
providing a sensor operative to measure a temperature of each gearbox;
monitoring the temperature in each gear box; and
one of reducing a travel speed of the mower and increasing a cutting height of the mower when the temperature in one of the gearboxes increases to a maximum acceptable temperature.

7. The method of claim 6 further comprising providing an alarm operative to alert an operator that the temperature of a gearbox exceeds the maximum acceptable temperature.
